(19) United States
(12) Patent Application Publication
(10) Pub. No.: US 2006/0067293 A1
(43) Pub. Date: Mar. 30, 2006

(54) Digital synthesis of communication signals

(76) Inventors: John Santhoff, Carlsbad, CA (US); Steve Moore, Escondido, CA (US)

Correspondence Address: PULSE-LINK, INC., 1969 KELLOGG AVENUE, CARLSBAD, CA, 92008, US

(21) Appl. No.: 10/950,056

(22) Filed: Sep. 24, 2004

(51) Int. Cl. H04B 7/212

(52) U.S. Cl. 370/347

(57) ABSTRACT

The present invention provides apparatus, systems and methods for directly digitally synthesizing communication signals or waveforms. That is, waveforms that carry data are generated by a digital-to-analog converter (DAC) at the radio frequency used to transmit the waveforms. One embodiment of the present invention comprises a digital processor configured to encode data onto one or more representative transmission symbols. A waveform generator, such as a high-speed DAC, is configured to generate a waveform from the encoded representative transmission symbols. The waveform is then transmitted. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

### FIELD OF THE INVENTION

The present invention generally relates to communications. More particularly, the invention concerns a method for digitally synthesizing communication signals.

### BACKGROUND OF THE INVENTION

Requirements for information transmission capacity have increased since the invention of radio. Marconi's original spark transmitter enabled point-to-point Morse code communications in the late 1800's, but was soon superceded by heterodyne and superheterodyne continuous wave transmitters that predicated the hugely successful, burgeoning AM radio industry of the 1920's. Shortwave and FM radio followed over the decades, leading eventually to modern digital communications. As the industry has grown and technologies progressed, the airwaves have filled, which has led to a need for efficient radio frequency (RF) usage. Consequently, an emphasis has been placed on methods that deliver a maximum amount of information over RF channels.

Modulating a carrier wave with a baseband, or information, signal has been the basis of conventional RF communications since the advent of continuous wave transmitters. Each information channel uses a different carrier wave spaced far enough away in frequency from adjacent carriers to avoid interference. Under this approach, a single information channel thus modulates a single carrier wave.

There are limits to the amount of information that any single channel may carry. However, the information needs of today's consumers and business' are pushing those limits. Once a communication channel nears saturation, various strategies are implemented to increase the information transfer rate (i.e., data rate, or bandwidth).

A general solution to increase data rates is to employ “multiplexing” techniques, such as frequency division multiplexing (FDM). Rather than pushing a data stream through a single RF channel, it is possible to partition the stream into blocks and modulate some fixed number of blocks in parallel, putting each onto separate “sub-carrier” waves at slower transmission rates. The modulated subcarriers are subsequently summed into a composite waveform or signal and transmitted. Upon reception, the composite signal is broken back down to its component subcarrier frequencies from which the data are extracted. FDM requires, however, that the subcarrier frequencies be spaced far enough apart to prevent interference, leading to comparative inefficiencies in frequency use.

A more efficient method of FDM lies in the use of mutually “orthogonal” subcarriers, called orthogonal frequency division multiplexing (OFDM). Here, “orthogonal” means that the modulated carriers essentially do not interfere with each other, but are yet closely packed together in frequency. Closely packing the multiple subcarrier frequencies results in an important efficiency gain because the radio frequency occupied by the OFDM signal is minimized.

In practice, OFDM requires a method to generate each of the orthogonal subcarrier frequencies. Historically, a separate oscillator was used to produce each subcarrier wave, but the oscillators had to be carefully synchronized to ensure proper coherence between the subcarriers in the final composite waveform, adding significant complexity and cost to the OFDM system. A later approach provided a significant improvement by eliminating the need for a bank of synchronized, separate oscillators, using instead a digital signal processing (DSP) module. Here, an input data stream of binary digits, or “bit stream,” is mapped into a sequence of code symbols that is subjected to an inverse fast fourier transform (inverse FFT, or IFFT) in the DSP module. The IFFT produces a sequence of orthogonal time domain signals (i.e., the orthogonal subcarriers for the OFDM signal). This method generates the orthogonal subcarriers numerically by using a dedicated computing module, instead of a bank of synchronized oscillators.

However, the radio frequency band of the subcarriers generated by the IFFT process are fixed according to a “width” of the IFFT and the sampling rate of the DSP, which are both limited by hardware and software designs. Moreover, a basic computational requirement of the IFFT algorithm is that the length of the data sequence on which the operation is performed must generally be some number equal to 2 to the N^{th} power (i.e., 2^{N}), such as 512, 1024, or 2048, thereby limiting flexibility. The orthogonal subcarriers must then be summed, but the resulting composite signal still requires low-pass filtering and up-conversion using a local oscillator to the radio frequency used for transmission.

All of these steps require dedicated hardware, software and are computationally intensive. Therefore, there exists a need for an apparatus, systems and methods to increase communication channel data rates in an efficient manner.

### SUMMARY OF THE INVENTION

In order to combat the above problems, the present invention provides apparatus, systems and methods to simplify communication devices, while achieving high data rates.

One embodiment of the present invention replaces the IFFT, the low pass filter, and the up-conversion step that requires a local oscillator, with a digital processor and a single high-speed digital-to-analog converter (DAC). One feature of this embodiment is that several hardware and software components are eliminated, and previously unobtainable design flexibility can now be realized.

This embodiment of the present invention synthesizes, or generates communication signals directly, which can then be transmitted, without “up-conversion” to the transmission frequency, and without many of the processing steps used in conventional communication devices.

For example, one embodiment of the present invention comprises a digital processor configured to encode data onto one or more representative transmission symbols. A waveform generator, such as a high-speed DAC, is configured to generate a waveform from the encoded representative transmission symbols. This waveform is then passed to an antenna and transmitted.

By using a high-speed DAC, such as one having a sampling rate of at least 10 giga samples per second, communication signals can be generated directly at their transmission frequency, including transmission frequencies of 5 gigahertz and above.

Another feature of the present invention is that in one embodiment, only one DAC is required, as its high speed allows it to generate multiple communication signals at different frequencies, thereby eliminating the need for many components, such as multiple field-programmable-gate-arrays (FPGAs) found in conventional communication devices.

These and other features and advantages of the present invention will be appreciated from review of the following detailed description of the invention, along with the accompanying figures in which like reference numerals are used to describe the same, similar or corresponding parts in the several views of the drawings.

### BRIEF DESCRIPTION OF THE DRAWINGS

FIG. 1 illustrates a conventional method of orthogonal frequency division multiplexing;

FIG. 2 illustrates an orthogonal frequency division multiplexing method constructed according to one embodiment of the present invention;

FIG. 3 illustrates a method to synthesize virtually any waveform according to another embodiment of the present invention;

FIG. 4 illustrates different communication methods;

FIG. 5 illustrates two ultra-wideband pulses;

FIG. 6 illustrates a 16-point quadrature amplitude modulation “constellation;”

FIG. 7 illustrates the data transformations for orthogonal frequency division multiplexing performed by another embodiment of the present invention;

FIG. 8 illustrates a portion of a digital-to-analog converter that can directly synthesize waveforms consistent with one embodiment of the present invention;

FIG. 9 illustrates of a current switching circuit shown in FIG. 8;

FIG. 10 illustrates several different communication signals that can be generated by one embodiment of the present invention;

FIG. 11 illustrates portions of an ultra-wideband pulse and a 802.11(a) communication signal; and

FIG. 12 illustrates a portion of a combined signal comprising the signals illustrated in FIG. 11.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE INVENTION

In the following paragraphs, the present invention will be described in detail by way of example with reference to the attached drawings. While this invention is capable of embodiment in many different forms, there is shown in the drawings and will herein be described in detail specific embodiments, with the understanding that the present disclosure is to be considered as an example of the principles of the invention and not intended to limit the invention to the specific embodiments shown and described. That is, throughout this description, the embodiments and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention provides apparatus, systems and methods for directly digitally synthesizing communication signals or waveforms. That is, waveforms that carry data are generated by a digital-to-analog converter (DAC) at the radio frequency used to transmit the waveforms. This contrasts with conventional communication methods that generate the waveforms at one frequency and transmit them at another frequency. By employing a high-speed DAC, the present invention can generate waveforms having a transmission radio frequency that may range from 5 megahertz (MHz) to at least 5 gigahertz (GHz), with higher frequencies, such as 10 GHz and higher also obtainable.

The communication signals, or waveforms may be in the form of electromagnetic waves, discrete electromagnetic pulses, wavelets or other types of communication signals.

One embodiment of the present invention provides a method for performing frequency division multiplexing (FDM). This embodiment directly synthesizes the modulated, digital time domain waveforms that comprise the subcarriers. Information desired for transmission may be modulated, or encoded onto each subcarrier, which prior to synthesis is represented as a group of numerical values. During syntheses by a waveform generator, such as a digital-to-analog converter (DAC), the subcarrier waveforms may be constructed to possess any desired characteristic. For example, a high-speed DAC takes the numerical values that represent the subcarrier waveforms and converts the numbers to an analog waveform for transmission through a communication channel, which may be air, space, water, wire, cable, optical fiber, or other communication channels.

Another embodiment of the present invention provides mutually orthogonal synthesized subcarrier waveforms, thereby creating orthogonal frequency division multiplexing (OFDM) waveforms. One version of this embodiment creates the OFDM waveforms at the radio frequency used for transmission. That is, the synthesized waveforms do not require up-conversion to the communication channel frequency. In this version, a DAC with a sampling rate of 20 giga samples per second may employed, allowing frequency content up to 10 GHz to be accurately represented in the transmitted waveform. DACs with slower, or faster sampling rates may be employed, depending upon the desired transmission frequency. One method for modulating the information onto the subcarriers comprises quadrature amplitude modulation (QAM), but other modulation (i.e., encoding) methods, such as the various forms of phase shift keying (PSK) or differential phase shift keying (DPSK), may be employed in other embodiments.

One feature of this embodiment is that the portion of the radio frequency spectrum (i.e., the radio frequency band) occupied by the orthogonal subcarriers may conform to the specifications of existing, deployed OFDM systems. Also, because the IFFT process is no longer required, data processing is not limited to the 2^{N} data sequence length of conventional OFDM systems (discussed is the Background of the Invention), thereby increasing efficiency, and increasing system flexibility. Thus, the present invention can directly replace older OFDM transceivers, and enable new OFDM system designs. In addition, the present invention reduces the number of components required to build a transceiver, thereby reducing manufacturing costs, and permits reductions in transceiver size and power consumption.

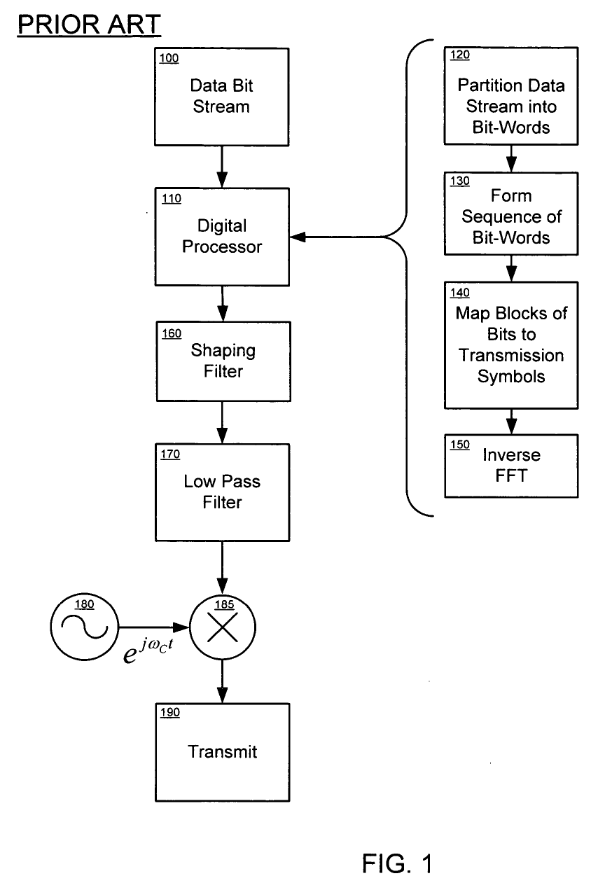

Referring to FIG. 1, which illustrates the processing steps generally employed by a conventional OFDM communication system. In step 100, information to be transmitted is formed into a binary data bit stream. In step 110, the data bit stream is routed to a digital processor, which may be a digital signal processor. In step 120, the digital signal processor partitions the data bit stream into blocks or bit-words of a pre-determined length. In step 130, a fixed number of bit-words, determined by design limits, are used to form a sequence of bit-words. In step 140, the sequence of bit-words are then converted or “mapped” into transmission symbols using techniques such as phase shift keying (PSK) or differential phase shift keying (DPSK), creating a sequence of transmission symbols. In step 150, the sequence of transmission symbols is then converted by an inverse digital fourier transform (inverse DFT), or an IFFT process.

The product of the IFFT process is a sequence of complex values, each representing a frequency and phase in the time domain. The frequencies generated by the IFFT process constitute the OFDM subcarriers because they are mutually orthogonal due to the orthogonal characteristics of the IFFT process. Each specific frequency is a function of the system sampling rate and the “width” of the IFFT (i.e., 2^{N} for some N). Information, or data is represented in an individual subcarrier waveform according to the method that was used to map the data into transmission symbols in step 140. In step 160, the output of the IFFT is then routed through a shaping filter, followed by a low pass filter, in step 170. In step 185, the filtered waveform is then “up-converted” to the radio frequency used for transmission (i.e., the carrier frequency, ω_{C}), which requires mixing with a sinusoidal waveform e^{jω}^{_{C}}^{t} (in step 180), which is generated by a local oscillator. In step 190, the resulting modulated waveform is then transmitted, generally by an antenna (not shown).

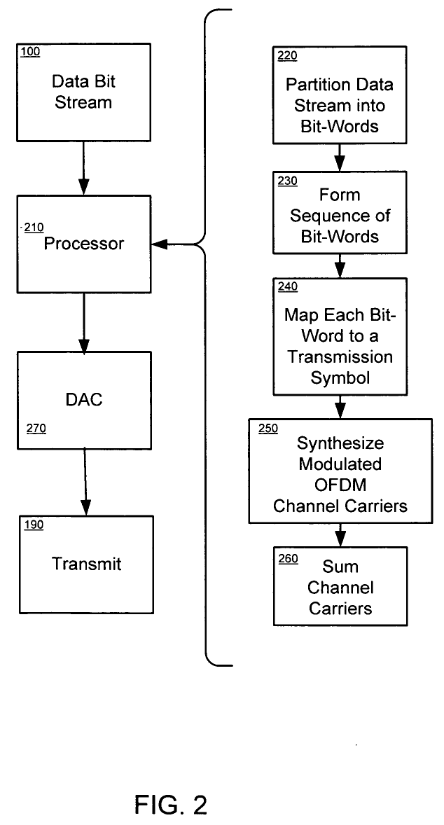

Referring now to FIG. 2, which illustrates one embodiment of the present invention that generates OFDM communication waveforms precisely at the radio frequency used for transmission. In step 100, a data bit stream of interest, such as voice, video, audio, or Internet content is obtained. In step 210 the data bit stream is passed to the processor. The processor may comprise one or more discrete components, and may include a finite state machine, a digital signal processor, and/or computer logic steps stored in memory or built into digital hardware. It will be appreciated that other components may comprise the processor.

In step 220, the bit stream is partitioned into bit-words, or groups of bits. The length of each bit-word depends primarily upon the modulation method selected. In step 230, a desired number of bit-words are then used to form a sequence of bit-words. In step 240, each bit-word in the sequence is then converted or “mapped” into a transmission or data symbol, resulting in a sequence of transmission symbols that now include the OFDM modulation.

In step 250, the transmission symbols are used to modulate, or encode subcarrier waveforms that are represented as numerical values. That is, the encoding of data onto the representation of communication waveforms is performed digitally by algorithms that generate numerical values representing the now encoded communication waveforms.

In step 260, the modulated “time domain” subcarrier waveforms are summed, resulting in a digitized, or “sampled,” version of the final transmission waveform.

In step 270, this digital sequence is passed to the digital-to-analog converter (DAC) for conversion to an analog waveform that is then transmitted in step 190. It will be appreciated that the transmission step 190 may employ one or more antennas, amplifiers and/or filters to facilitate transmission over the communication channel of interest, and/or other components necessary to accomplish signal transmission at the chosen radio frequency and through the chosen communication medium.

One feature of the present invention is that the now modulated time domain communication waveforms are synthesized, or created at the radio frequencies used for transmission. By employing this method of direct digital synthesis, the shaping filter (step 160), low pass filter (step 170), oscillator (step 180) and mixer, or up-converter (step 185), all required in conventional OFDM systems, are eliminated. This reduces manufacturing cost, and subsequent retail cost, as well as reducing product size and power requirements. In addition, the entire IFFT process is eliminated, resulting in greater processing flexibility because the 2^{N} sampling rate is no longer necessary.

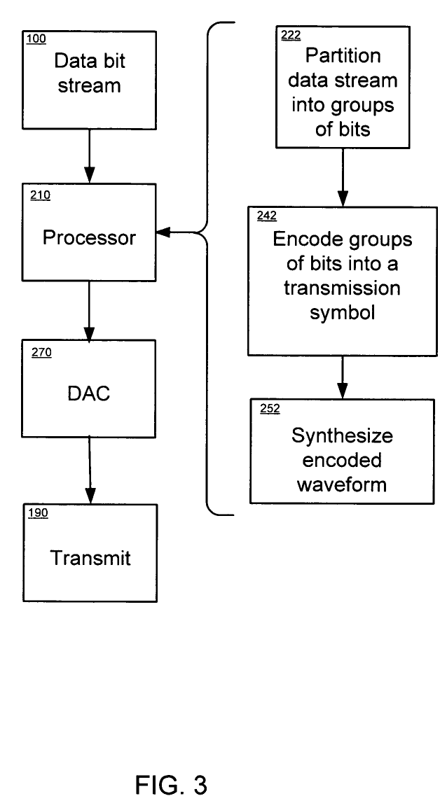

Referring now to FIG. 3, another embodiment of the present invention is illustrated. In this embodiment, any type of waveform, or modulated waveform may be generated. That is, in addition to the method for generating OFDM-modulated signals discussed with reference to FIG. 2, the present invention can directly synthesize any desired communication signal, that may be modulated by any known, or yet to be developed, modulation method. For example, in addition to OFDM modulation, the present invention can employ amplitude modulation, phase modulation, frequency modulation, quadrature amplitude modulation, pulse-code modulation, pulse-width modulation, pulse-amplitude modulation, pulse-position modulation, frequency-shift keying, phase-shift keying, and any other type of modulation method.

Moreover, the present invention can directly generate discrete electromagnetic pulses, rather than the substantially continuous sinusoidal waveforms used in conventional communication systems. One communication technology that employs discrete electromagnetic pulses is known as “ultra-wideband” or impulse radio.

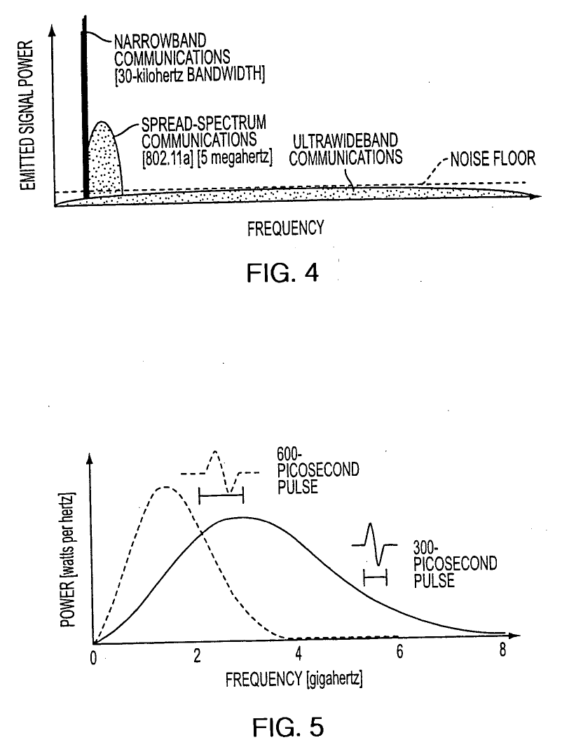

Referring to FIGS. 4 and 5, impulse radio, or ultra-wideband (UWB) communication employs discrete pulses of electromagnetic energy that are emitted at, for example, nanosecond or picosecond intervals. That is, the UWB pulses may be transmitted without modulation onto a sine wave, or a sinusoidal carrier, in contrast with conventional carrier wave communication technology, such as a conventional OFDM communication technology, as described above. UWB generally requires neither an assigned frequency nor a power amplifier.

Alternate embodiments of UWB may be achieved by mixing baseband pulses (i.e., information-carrying pulses), with a carrier wave that controls a center frequency of a resulting signal. The resulting signal is then transmitted using discrete pulses of electromagnetic energy, as opposed to transmitting a substantially continuous sinusoidal signal.

An example of a conventional carrier wave communication technology is illustrated in FIG. 4. IEEE 802.11a is a wireless local area network (LAN) protocol, which transmits a sinusoidal radio frequency signal at a 5 GHz center frequency, with a radio frequency spread of about 5 MHz. As defined herein, a carrier wave is an electromagnetic wave of a specified frequency and amplitude that is emitted by a radio transmitter in order to carry information. The 802.11 protocol is an example of a carrier wave communication technology. The carrier wave comprises a substantially continuous sinusoidal waveform having a specific narrow radio frequency (5 MHz) that has a duration that may range from seconds to minutes.

In contrast, an ultra-wideband (UWB) pulse may have a 2.0 GHz center frequency, with a frequency spread of approximately 4 GHz, as shown in FIG. 5, which illustrates two typical UWB pulses. FIG. 5 illustrates that the shorter the UWB pulse in time, the broader the spread of its frequency spectrum. This is because bandwidth is inversely proportional to the time duration of the pulse. A 600-picosecond UWB pulse can have about a 1.8 GHz center frequency, with a frequency spread of approximately 1.6 GHz and a 300-picosecond UWB pulse can have about a 3 GHz center frequency, with a frequency spread of approximately 3.2 GHz. Thus, UWB pulses generally do not operate within a specific frequency, as shown in FIG. 4. Either of the pulses shown in FIG. 5 may be frequency shifted, for example, by using heterodyning, to have essentially the same bandwidth but centered at any desired frequency. And because UWB pulses are spread across an extremely wide frequency range, UWB communication systems allow communications at very high data rates, such as 100 megabits per second or greater.

Also, because the UWB pulses are spread across an extremely wide frequency range, the power sampled in, for example, a one megahertz bandwidth, is very low. For example, UWB pulses of one nano-second duration and one milliwatt average power (0 dBm) spreads the power over the entire one gigahertz frequency band occupied by the pulse. The resulting power density is thus 1 milliwatt divided by the 1,000 MHz pulse bandwidth, or 0.001 milliwatt per megahertz (−30 dBm/MHz).

Generally, in the case of wireless communications, a multiplicity of UWB pulses may be transmitted at relatively low power density (milliwatts per megahertz). However, an alternative UWB communication system may transmit at a higher power density. For example, UWB pulses may be transmitted in a range between 30 dBm to −50 dBm.

UWB pulses may also be transmitted through wire, cables, fiber-optic cables, and UWB pulses transmitted through many wire media will not interfere with wireless radio frequency transmissions. Therefore, the power (sampled at a single frequency) of UWB pulses transmitted though wire media may range from about +30 dBm to about −140 dBm.

Several different methods of ultra-wideband (UWB) communication have been proposed. For wireless UWB communications in the United States, all of these methods must meet the constraints recently established by the Federal Communications Commission (FCC) in their Report and Order issued Apr. 22, 2002 (ET Docket 98-153). Currently, the FCC is allowing limited UWB communications, but as UWB systems are deployed, and additional experience with this new technology is gained, the FCC may expand the use of UWB communication technology.

The April 22 Report and Order requires that UWB pulses, or signals occupy greater than 20% fractional bandwidth or 500 megahertz, whichever is smaller. Fractional bandwidth is defined as 2 times the difference between the high and low 10 dB cutoff frequencies divided by the sum of the high and low 10 dB cutoff frequencies. Specifically, the fractional bandwidth equation is:

$$Fractional Bandwidth = 2 \frac{{f}_{h} - {f}_{l}}{{f}_{h} + {f}_{l}}$$

where ƒₕ is the high 10 dB cutoff frequency, and ƒₗ is the low 10 dB cutoff frequency.

Stated differently, fractional bandwidth is the percentage of a signal's center frequency that the signal occupies. For example, a signal having a center frequency of 10 MHz, and a bandwidth of 2 MHz (i.e., from 9 to 11 MHz), has a 20% fractional bandwidth. That is, center frequency, ƒ_{c}=(ƒₕ+fₗ)/2. However, UWB as defined by the present invention is not limited to the current FCC definition. As discussed above, UWB is a form of impulse communications, and some embodiments may not fit within the current FCC definition.

Communication standards committees associated with the International Institute of Electrical and Electronics Engineers (IEEE) are considering a number of ultra-wideband (UWB) wireless communication methods that meet the constraints established by the FCC. One UWB communication method may transmit UWB pulses that occupy 500 MHz bands within the 7.5 GHz FCC allocation (from 3.1 GHz to 10.6 GHz). In one embodiment of this communication method, UWB pulses have about a 2-nanosecond duration, which corresponds to about a 500 MHz bandwidth. The center frequency of the UWB pulses can be varied to place them wherever desired within the 7.5 GHz allocation. In another embodiment of this communication method, an Inverse Fast Fourier Transform (IFFT) is performed on parallel data to produce 122 carriers, each approximately 4.125 MHz wide. In this embodiment, also known as Orthogonal Frequency Division Multiplexing (OFDM), the resultant UWB pulse, or signal is approximately 506 MHz wide, and has a 242 nanosecond duration. It meets the current FCC rules for UWB communications because it is an aggregation of many relatively narrow band carriers rather than because of the duration of each pulse.

Another UWB communication method being evaluated by the IEEE standards committees comprises transmitting discrete UWB pulses that occupy greater than 500 MHz of frequency spectrum. For example, in one embodiment of this communication method, UWB pulse durations may vary from 2 nanoseconds, which occupies about 500 MHz, to about 133 picoseconds, which occupies about 7.5 GHz of bandwidth. That is, a single UWB pulse may occupy substantially all of the entire allocation for communications (from 3.1 GHz to 10.6 GHz).

Yet another UWB communication method being evaluated by the IEEE standards committees comprises transmitting a sequence of pulses that may be approximately 0.7 nanoseconds or less in duration, and at a chipping rate of approximately 1.4 giga pulses per second. The pulses are modulated using a Direct-Sequence modulation technique, and is called DS-UWB. Operation in two bands is contemplated, with one band is centered near 4 GHz with a 1.4 GHz wide signal, while the second band is centered near 8 GHz, with a 2.8 GHz wide UWB signal. Operation may occur at either or both of the UWB bands. Data rates between about 28 Megabits/second to as much as 1,320 Megabits/second are contemplated.

Thus, described above are three different methods of ultra-wideband (UWB) communication. It will be appreciated that the present invention may be employed by any of the above-described UWB methods, or others yet to be developed.

Referring again to FIG. 3, which illustrates another method of the present invention that may be used in the direct digital synthesis of virtually any communication signal. Similar to FIG. 2, in step 100, data of interest, such as voice, video, audio, text, Internet content, or any other data of interest, is obtained. In step 210 the data, in the form of binary digits, such as a bit stream is passed to the processor. The processor may comprise one or more discrete components, and may include a finite state machine, a digital signal processor, and/or computer logic steps stored in memory or built into digital hardware. It will be appreciated that other components may comprise the processor.

In step 222, the bit stream is partitioned into groups of bits. The size of each bit group depends primarily upon the employed modulation method. In step 242, each group of bits is then converted or “mapped” into a data symbol, resulting in a sequence of transmission, or data symbols. That is, the bit groups are changed in numerical value by the modulation method that is employed.

In step 252, the now modulated bit groups are combined with a chosen waveform. For example, a waveform representing a sinusoidal carrier wave may be used. That is, the data symbols are used to modulate, or encode waveforms that are represented as numerical values. Put differently, the encoding of data onto the representation of communication waveforms is performed digitally by algorithms that generate numerical values representing the now encoded communication waveforms.

In step 270, this digital sequence is passed to the digital-to-analog converter (DAC) for conversion to an analog waveform that is then transmitted in step 190. It will be appreciated that the transmission step 190 may employ one or more antennas, amplifiers and/or filters to facilitate transmission over the communication channel of interest, and/or other components necessary to accomplish signal transmission at the chosen radio frequency and through the chosen communication medium.

One feature of the present invention is that the now modulated time domain communication waveforms are synthesized, or created at the radio frequencies used for transmission. By employing this method of direct digital synthesis, the shaping filter (step 160), low pass filter (step 170), oscillator (step 180) and mixer, or up-converter (step 185), all required in conventional OFDM systems, are eliminated. This reduces manufacturing cost, and subsequent retail cost, as well as reducing product size and power requirements. In addition, the entire IFFT process is eliminated, resulting in greater processing flexibility because the 2^{N} sampling rate is no longer necessary. These features reduce manufacturing and subsequent retail cost, as well as reduce product size and power requirements.

The final analog waveform transmitted in step 190 may be a substantially continuous sinusoidal waveform having a duration that may last between milliseconds to minutes and hours, or the analog waveform may be in the form of discrete pulses of electromagnetic energy, used in impulse communications, such as ultra-wideband, and other forms of impulse communications.

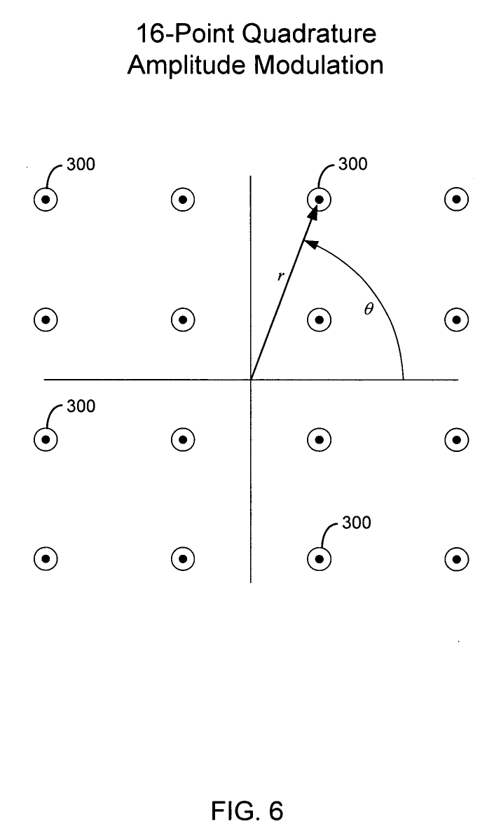

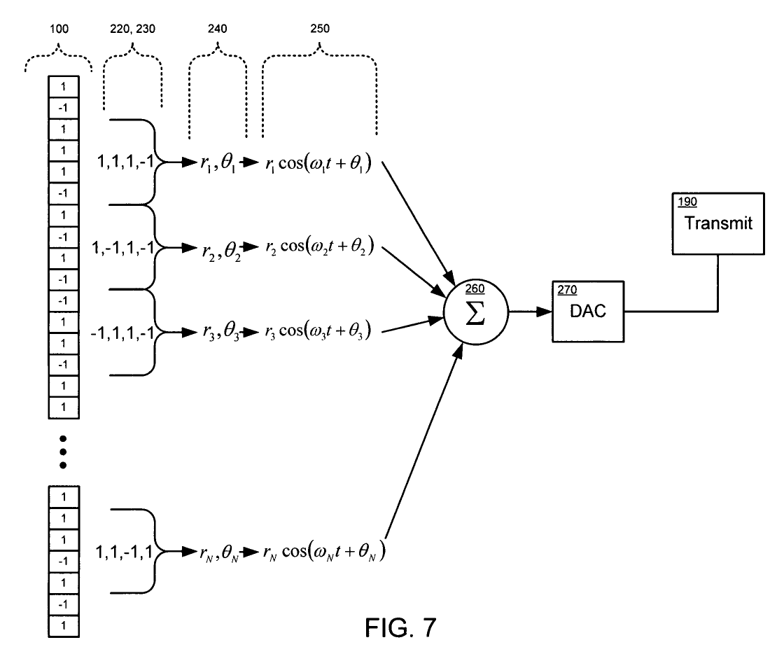

Referring now to FIGS. 6 and 7, one type of modulation method, and its use in one embodiment of the present invention, is illustrated. FIG. 6 illustrates a 16-point quadrature amplitude modulation (QAM) arrangement, or “constellation.” In this modulation method, well-known in the art, a bit-word consists of four bits, thus there are 16 possible combinations of bit-words (2⁴=16). Using this modulation method, the bit-words generated in step 220 would contain four bits. The mapping step 240 (shown in FIG. 2) then comprises mapping each 4-bit word to one of 16 transmission symbols representing specific, unique combinations of amplitude and phase angle. FIG. 6 depicts a 16-point QAM mapping “constellation,” where each of the 16 points 300 represents a transmission symbol comprising a specific amplitude r and phase angle θ. Once all the bit-words are “mapped,” then in synthesis step 250, a digital pulse of a specific duration is generated. The digital pulse represents a subcarrier waveform as modulated by the amplitude and phase of the QAM transmission symbol.

The steps of mapping 240 and synthesizing 250 are performed for all of the bit-words generated in the bit-word sequence formation step 230. In the OFDM embodiment illustrated in FIG. 2, the order of the bit-words generated in the bit sequence step 230 corresponds to the order in which each bit-word's component bits were originally partitioned in step 220, and this order of bit-words is continued through the mapping 240 and synthesizing 250 steps.

FIG. 7 illustrates this sequence of bit-word ordering by presenting another depiction of the method illustrated in FIG. 2. The data bit stream 100 (shown as 1 and −1 bits) is partitioned into 4-bit words, discussed in FIG. 2 as steps 220 and 230. There are N words comprising a word sequence, and each word is mapped into the QAM constellation shown in FIG. 6, resulting in a new sequence of transmission symbols (rᵢ, θᵢ) for i=1 to N, where each (rᵢ, θᵢ) is drawn from the set of 16 points in the constellation (FIG. 2, step 240). The synthesis step generates a sequence of time domain waveforms rᵢ cos (ωᵢ+θᵢ) for i=1 to N, where each ωᵢ is selected to be mutually orthogonal to all ωⱼ, for j=1 to N, j≠i, thus creating discrete samples representing a set of orthogonal subcarriers, as required for OFDM (FIG. 2, step 250). The samples are summed (FIG. 2, step 260) and the resulting summed samples are passed to the high-speed digital-to-analog converter (DAC) 270, that generates a waveform from the summed samples at the desired transmission frequency, which is then transmitted 190.

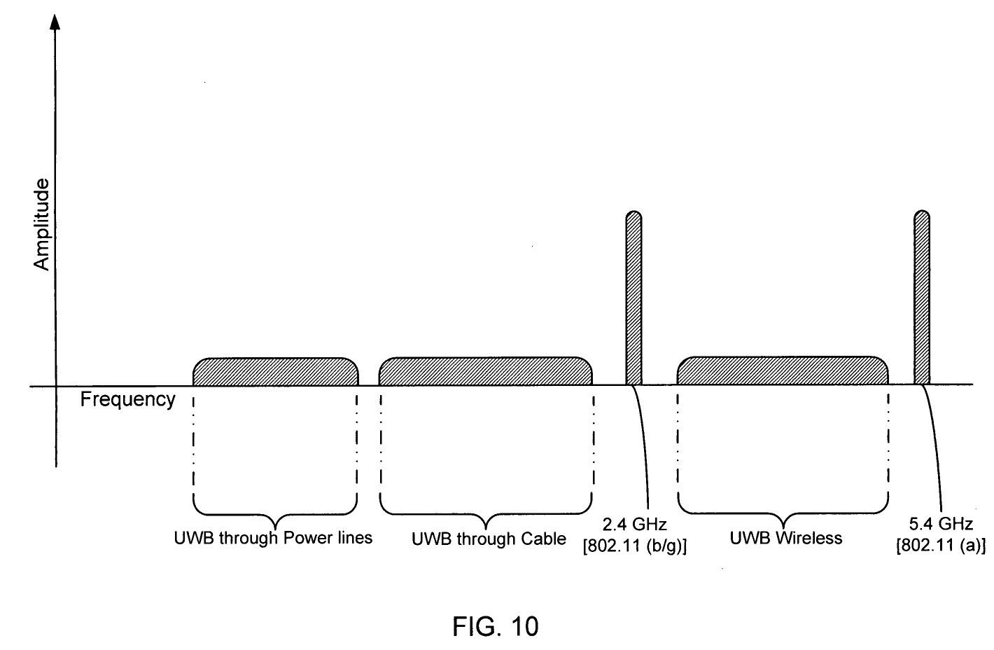

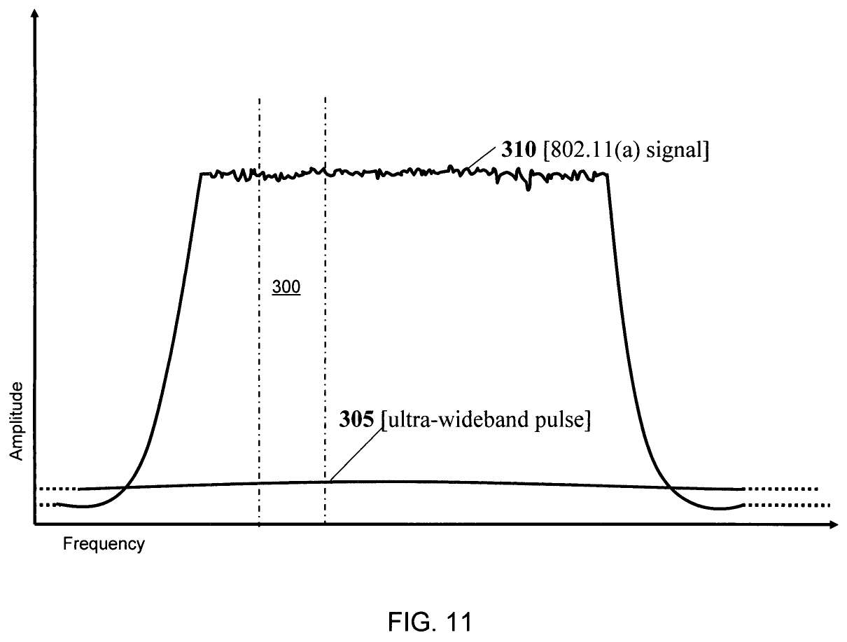

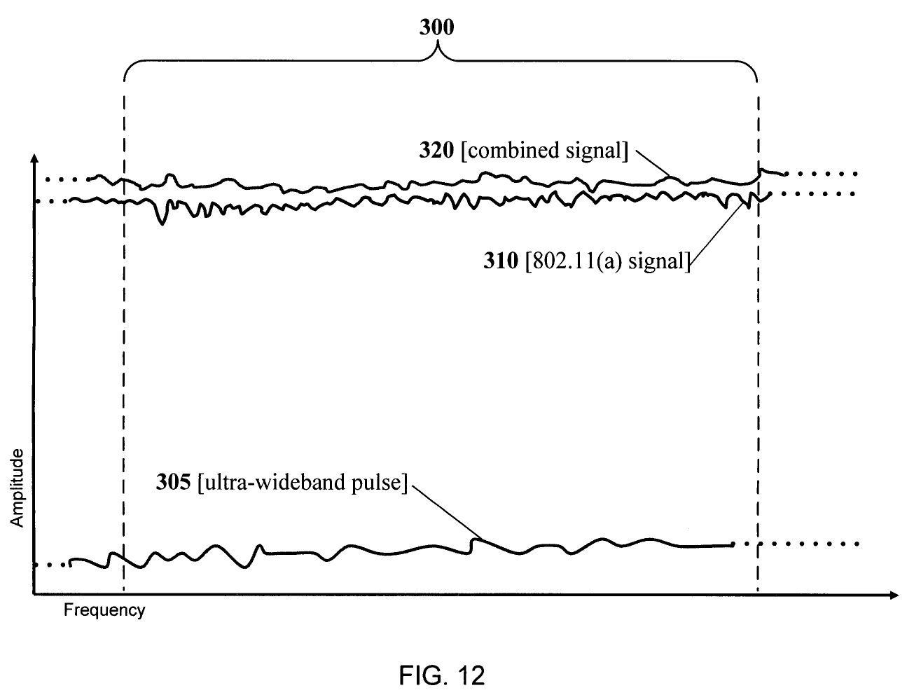

Referring now to FIGS. 10-12, further embodiments of the present invention are illustrated. In addition to synthesizing waveforms incorporating modulation methods, one embodiment of the present invention can simultaneously synthesize multiple waveforms, each incorporating their own modulation. For example, with reference to FIGS. 11 and 12, an 802.11(a) signal 310 is shown with an ultra-wideband pulse 305. The 802.11(a) signal 310 comprises a sinusoidal waveform incorporating either OFDM, direct sequence modulation, or another suitable modulation method. The ultra-wideband pulse 305 comprises a discrete pulse of electromagnetic energy that may incorporate many different modulation methods.

Referring now to FIG. 12, one feature of the present invention is that both the 802.11(a) signal 310 and the ultra-wideband pulse 305 may be synthesized by the methods disclosed herein to form a combined signal 320. A signal section 300 is shown in both FIGS. 11 and 12, with FIG. 12 showing the combined signal 320, and both the 802.11(a) signal 310 and the ultra-wideband pulse 305.

For example, with reference to FIG. 3, to generate or synthesize a combined signal 320, in step 222 data for each signal may be partitioned into groups, and in step 242 each group of bits is then converted or “mapped” into a data symbol, resulting in a sequence of transmission, or data symbols. That is, the bit groups are changed in numerical value by the modulation method that is employed.

In step 252, the now modulated bit groups are combined with chosen waveforms. For example, when generating a combined signal 320, a waveform representing a sinusoidal carrier wave may be generated, and an ultra-wideband pulse may also be generated. Once the waveforms are generated the data symbols are used to modulate, or encode the waveforms, which are represented as numerical values. That is, the encoding of data onto the two, or more representations of communication waveforms is performed digitally by algorithms that generate numerical values representing the now encoded communication waveforms.

The two encoded waveforms are now numerically summed, resulting in numerical values that represent a combined communication signal. In step 270, this digital sequence is passed to the digital-to-analog converter (DAC) for conversion to an analog waveform resulting in combined signal 320 that is then transmitted in step 190. It will be appreciated that the transmission step 190 may employ one or more antennas, amplifiers and/or filters to facilitate transmission over the communication channel of interest, and/or other components necessary to accomplish signal transmission at the chosen radio frequency and through the chosen communication medium.

With reference now to FIG. 10, it will also be appreciated that virtually any type, and numbers of communication signals, each incorporating virtually any type of modulation method may be generated, simultaneously or sequentially, by the present invention. In addition, these signals may be transmitted through any communication medium, such as air, wire, cable, space, or any other medium. For example, as shown in FIG. 10, multiple communication signals may be generated by the present invention, such as ultra-wideband (UWB) pulses that may be transmitted though power lines (illustrated as “UWB through Power lines”), cable (illustrated as “UWB through Cable”), and the air (illustrated as “UWB Wireless”). In addition, the present invention may also generate carrier waves, such as sinusoidal communication signals like 80211(b/g) and/or 802.11(a), or other conventional communication signals.

An example of a combined signal 320 may be an ultra-wideband pulse that may be transmitted though a power line at a frequency that may range from about 5 MHz to about 250 MHz, and simultaneously a 80211(b/g) signal that be transmitted at about 2.4 GHz. In this embodiment, the combined signal 320 may be passed through two or more band-pass filters that each may pass the desired signal's frequency (say, 10 MHz for the power line, and 2.4 GHz for the 802.11(b/g)), and filter the unwanted signal.

The DAC 270 of the present invention may generate communication signals up to, and beyond 10 GHz. Thus, as shown in FIG. 10, UWB wireless pulses may be generated within their current FCC-mandated frequency band of 3.1 GHz to 10.6 GHz, and a 802.11(a) signal may be generated at 5.4 GHz.

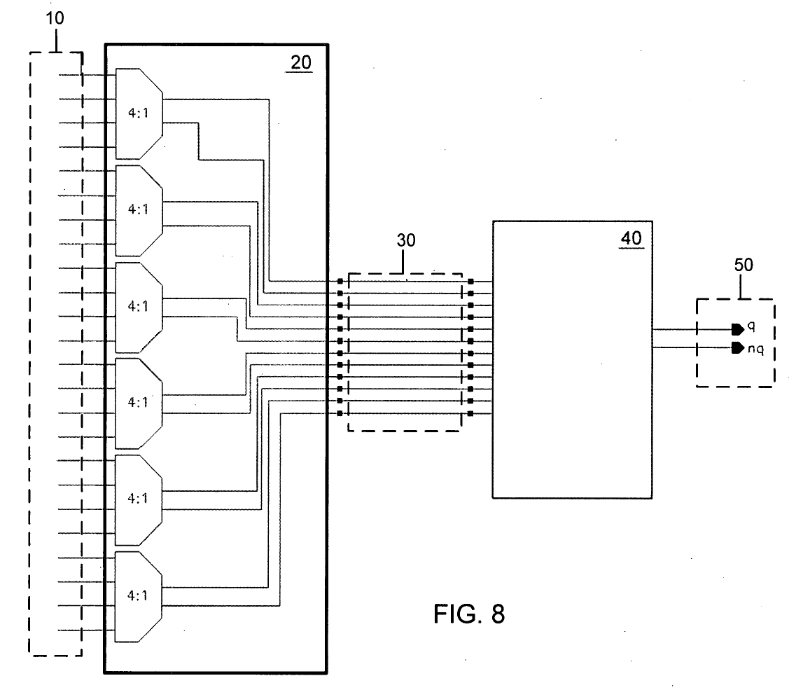

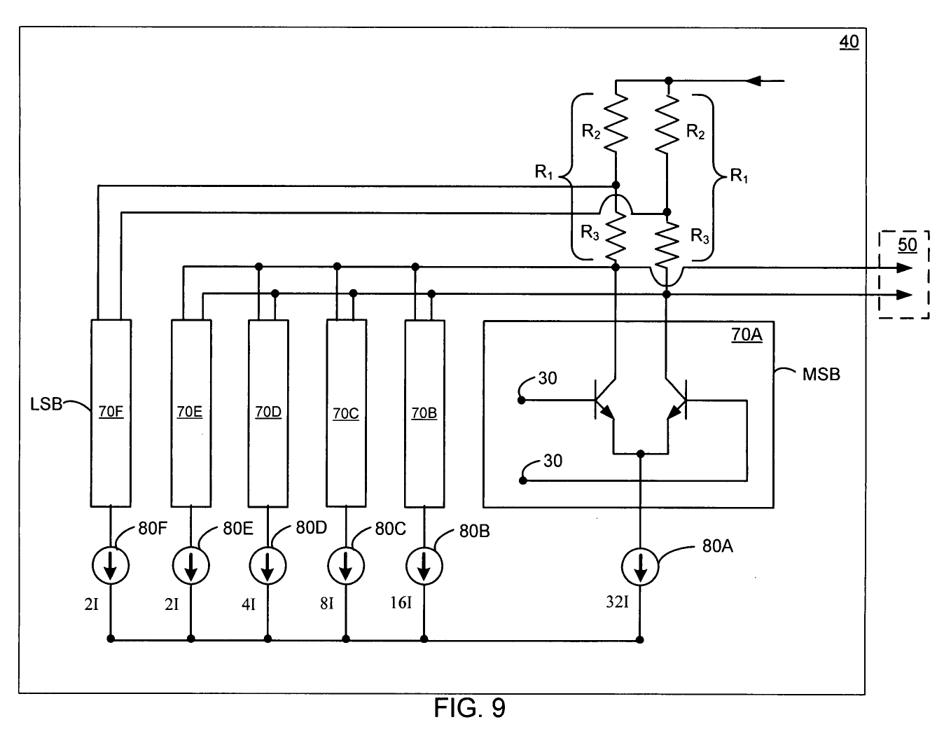

Referring now to FIGS. 8 and 9, the DAC 270 creates an analog waveform from the summed samples. A DAC is an electronic circuit that converts digital information (for example, the digital sequence of summed samples) into analog information, such as a waveform suitable for transmission. DACs are often characterized by their “sampling” rate, which is the interval that measurements of a source are taken. In the above-described example, the source is the digital sequence of summed samples. According to the well-known Nyquist sampling theorem, an analog waveform may be reconstructed from samples taken at equal time intervals, but the sampling rate must be equal to, or greater than, twice the highest frequency component in the analog waveform. That is, if the highest frequency component in an analog waveform is 5 gigahertz (GHz), then the sampling rate must be at least 10 GHz.

Conventional OFDM communication systems transmit in the 2.4 GHz and 5 GHz radio frequency bands. Therefore, the DAC 270 must have a sampling rate of at least 10 GHz to directly generate a 5 GHz radio frequency waveform.

Referring to FIGS. 8 and 9, a DAC 270 employed by the present invention has a sampling rate of at least 20 GHz, thereby enabling the direct generation of 10 GHz waveforms. To sample at 20 GHz, the DAC 270 includes a novel current switching circuit that assists in overcoming parasitic capacitance of the circuit elements.

Virtually all electronic components, such as transistors, have some capacitance. DACs generally include thousands of transistors. Under low speed operation the capacitance of an electronic component is usually not a limitation. Since impedance due to capacitance is a function of frequency, as the speed (i.e., frequency) of a circuit increases, the influence of capacitance becomes more significant. For example, parasitic effects that cause timing delays due to capacitor charging can affect circuit performance. In multi-bit DACs, the timing of currents must be precise. For a fixed capacitance, an increased amount of current can help overcome these, and other, parasitic effects.

The DAC of the present invention employs arrays of current sources. The current sources are not turned on and off but remain on during the operation of the DAC. As the digital input changes from one set of bits to another, the current sources are switched across a resistive load to form an output voltage

One type of “switched current” DAC architecture uses a number of current sources. The value of current in these sources typically increases by a power of 2 from one current source to another source, with the current sources starting with a base value. For example, if the current base value is I, then the circuit may have sources with values I, 2I, 4I, 8I, 16I, and 32I. In this case any individual current source can be expressed as Iₙ=2ⁿI, where I is the current base value.

Referring to FIG. 8, a novel component of a DAC employed by the present invention is illustrated. A differential parallel data bus 10 is input into multiplexers 20. The differential parallel data bus 10 receives data for processing by the DAC. In this design, the differential parallel data bus 10 can operate at an integer factor of 4 times slower than the DAC because of the 4 to 1 multiplexers 20. Thus, the multiplexers 20 run 4 times faster than the differential data bus 10. For example, if the multiplexers 20 operate at 12 GHz, the differential parallel data bus 10 operates at 3 GHz (¼ of 12), or if the multiplexers 20 operate at 20 GHz, the differential parallel data bus 10 operates at 5 GHz (¼ of 20).

The output from the multiplexers 20 is passed to the high-speed differential data bus 30. The high-speed data bus 30 operates at the same speed as the multiplexers 20. The high-speed data bus 30 sends differential data to the current switching network 40. Current switching network 40 uses the high-speed data bus 30 to form differential analog outputs 50.

FIG. 9 illustrates the current switching network 40. High speed data bus 30 inputs differential data into a bank of differential pair transistors 70A-F. One pair of inputs from the high speed data bus 30 is shown in differential pair transistor 70A. The other differential pair transistors 70B-F obtain data from the high speed data bus 30 in a similar fashion, but the high speed data bus 30 inputs are not shown for clarity.

The differential pair transistors 70A-F switch or steer current from current sources 80A-F through load resistors R₁-R₃. The high-speed data bus 30 is connected in order from the most significant bit (MSB) to the least significant bit (LSB), then to the differential pair transistors 70A-F that control switching for current sources 80A-F. For example, the MSB of the high-speed data bus 30 controls the switching of the differential pair transistor 70A connected to the largest current source 80A, which is 32 times the current (32I). Current sources 80A-F are stepped down in value by a factor of 2 moving from MSB to LSB (except at the LSB itself, where current source 80F is the same value as current source 80E, explained below).

In order to minimize the transition time from “on” to “off” for the differential pair transistors 70A-F, the state changing of each of the differential pair transistors 70A-F has to be precisely synchronized. Because of the large range of values provided by each current source 80A-F, which in this embodiment ranges from twice the current (2I) to 32 times the current (32I), and the parasitic capacitor effects, this precise timing is difficult to accomplish.

To achieve this precise timing, the LSB current is not halved with respect to next bit. That is, the current source 80F is the same as current source 80E. However, to achieve the same effect of having the LSB current ½ of the adjacent current (i.e., current of differential pair transistor 70F ½ of the current of differential pair transistor 70E), the load resistor R₁ is split to provide the current insertion point between load resistor R₂ and load resistor R₃. This split of load resistor R₁ allows the same output voltage to be developed at differential output 50 that would have been developed if the LSB current had been I instead of 2I. By having the differential pair transistors 70A-F NOT multiples of two of each other, the current spread is minimized, thereby allowing precise synchronization of state changing for all the differential pair transistors 70A-F.

A DAC 270 incorporating the features discussed above may have a sampling rate of at least 20 GHz, thus allowing it to directly generate a 10 GHz radio frequency waveform. It will be appreciated that the embodiments of the present invention relating to direct synthesis of communication waveforms at their transmission frequencies is not limited to DACs having 20 GHz sampling rates. As technology progresses, DAC sampling rates will increase, thereby allowing direct synthesis of communication waveforms at transmission frequencies greater than 10 GHz.

Thus, it is seen that an apparatus, systems and methods of direct synthesis of communication waveforms at their transmission frequencies is provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

What is claimed is:

1. A communication apparatus, comprising:
a single digital processor configured to encode data onto a representative transmission symbol;
a single waveform generator configured to generate a waveform from the representative transmission symbol; and
a single antenna configured to transmit the waveform.

2. The communication apparatus of claim 1, wherein the representative transmission symbol comprises at least one numerical value.

3. The communication apparatus of claim 1, wherein when the data is encoded onto the representative transmission symbol, at least one numerical value comprising the representative transmission symbol is changed.

4. The communication apparatus of claim 1, wherein the single waveform generator comprises a digital-to-analog converter that has a sampling rate of at least 5 giga-samples per second.

5. The communication apparatus of claim 1, wherein the single waveform generator generates the waveform at a radio frequency used to transmit the waveform.

6. The communication apparatus of claim 1, wherein the waveform is selected from a group consisting of: a substantially continuous sinusoidal signal, a discontinuous sinusoidal signal, an orthogonal frequency division multiplexed signal, an ultra-wideband pulse, an impulse radio pulse, and a plurality of discrete electromagnetic pulses.

7. A communication apparatus, comprising:
a digital processor configured to encode data onto a plurality of representative transmission symbols;
a single communication signal generator configured to generate at least two communication signals from the plurality of representative transmission symbols; and
at least one antenna configured to transmit the communication signals.

8. The communication apparatus of claim 7, wherein each of the plurality of representative transmission symbols comprises at least one numerical value.

9. The communication apparatus of claim 7, wherein when the data is encoded onto the plurality of representative transmission symbols, at least one numerical value comprising each of the plurality of representative transmission symbols is changed.

10. The communication apparatus of claim 7, wherein the single communication signal generator comprises a digital-to-analog converter that has a sampling rate of at least 5 giga-samples per second.

11. The communication apparatus of claim 7, wherein the single communication signal generator generates the at least two communication signals at different radio frequencies that are each used to transmit the at least two communication signals.

12. The communication apparatus of claim 7, wherein each of the at least two communication signals is selected from a group consisting of: a substantially continuous sinusoidal signal, a discontinuous sinusoidal signal, an orthogonal frequency division multiplexed signal, an ultra-wideband pulse, an impulse radio pulse, and a plurality of discrete electromagnetic pulses.

13. The communication apparatus of claim 7, wherein the data is encoded onto the representative transmission symbol by using a modulation method selected from a group consisting of: amplitude modulation, phase modulation, frequency modulation, single-sideband modulation, vestigial-sideband modulation, quadrature amplitude modulation, orthogonal frequency division modulation, pulse-code modulation, pulse-width modulation, pulse-amplitude modulation, pulse-position modulation, pulse-density modulation, frequency-shift keying, and phase-shift keying.

14. The communication apparatus of claim 7, wherein each of the at least two communication signals is transmitted through a communication medium selected from a group consisting of: a wire medium, a wireless medium, an optical fiber ribbon, a fiber optic cable, a single mode fiber optic cable, a multi-mode fiber optic cable, a twisted pair wire, an unshielded twisted pair wire, a plenum wire, a PVC wire, and a coaxial cable.

15. The communication apparatus of claim 7, wherein the at least two communication signals are both transmitted wirelessly.

16. The communication apparatus of claim 7, wherein the at least two communication signals are both transmitted through a wire medium.

17. The communication apparatus of claim 7, wherein the at least two communication signals are transmitted through a wire medium, and wirelessly.

18. A communication method, the method comprising the steps of:
encoding data onto a plurality of representative transmission symbols;
generating at least two communication signals from the plurality of representative transmission symbols; and
transmitting the communication signals.

19. The method of claim 18, wherein each of the plurality of representative transmission symbols comprises at least one numerical value.

20. The method of claim 18, wherein when the data is encoded onto the plurality of representative transmission symbols, at least one numerical value comprising each of the plurality of representative transmission symbols is changed.

21. The method of claim 18, wherein the single communication signal generator generates the at least two communication signals at different radio frequencies that are each used to transmit the at least two communication signals.

22. The method of claim 18, wherein each of the at least two communication signals is selected from a group consisting of: a substantially continuous sinusoidal signal, a discontinuous sinusoidal signal, an orthogonal frequency division multiplexed signal, an ultra-wideband pulse, an impulse radio pulse, and a plurality of discrete electromagnetic pulses.

23. The method of claim 18, wherein the data is encoded onto the representative transmission symbol by using a modulation method selected from a group consisting of: amplitude modulation, phase modulation, frequency modulation, single-sideband modulation, vestigial-sideband modulation, quadrature amplitude modulation, orthogonal frequency division modulation, pulse-code modulation, pulse-width modulation, pulse-amplitude modulation, pulse-position modulation, pulse-density modulation, frequency-shift keying, and phase-shift keying.

24. The method of claim 18, wherein each of the at least two communication signals is transmitted through a communication medium selected from a group consisting of: a wire medium, a wireless medium, an optical fiber ribbon, a fiber optic cable, a single mode fiber optic cable, a multi-mode fiber optic cable, a twisted pair wire, an unshielded twisted pair wire, a plenum wire, a PVC wire, and a coaxial cable.

25. The method of claim 18, wherein the at least two communication signals are both transmitted wirelessly.

26. The method of claim 18, wherein the at least two communication signals are both transmitted through a wire medium.

27. The method of claim 18, wherein the at least two communication signals are transmitted through a wire medium, and wirelessly.
